(19) United States
(12) Patent Application Publication
(10) Pub. No.: US 2023/0261338 A1
(43) Pub. Date: Aug. 17, 2023

(54) ELECTRODE STRUCTURE AND PRISMATIC BATTERY INCLUDING THE SAME

(71) Applicant: LG ENERGY SOLUTION, LTD., Seoul (KR)

(72) Inventors: Hee Cheon BOK, Daejeon (KR); Jin Soo LEE, Daejeon (KR); Joo Hwan SUNG, Daejeon (KR); Kyung Hwan JUNG, Daejeon (KR)

(21) Appl. No.: 18/109,016

(22) Filed: Feb. 13, 2023

(30) Foreign Application Priority Data
Feb. 14, 2022 (KR) 10-2022-0018632

(51) Int. Cl. H01M 50/538; H01M 50/553; H01M 50/103; H01M 50/593

(52) U.S. Cl. CPC H01M 50/538; H01M 50/553; H01M 50/103; H01M 50/593; H01M 2220/20

(57) ABSTRACT

The disclosed relates to an electrode structure including a pair of stack type electrode assemblies, and a prismatic battery including the same. The prismatic battery can be applied to various form factors of a prismatic secondary battery and has an excellent dimensional stability.

### CROSS-REFERENCE TO RELATED APPLICATIONS

This application claims priority under 35 U.S.C. 119(a) to Korean Patent Application No. 10-2022-0018632, filed on Feb. 14, 2022, the disclosure of which is incorporated by reference in its entirety for all purposes as if fully set forth herein.

### TECHNICAL FIELD

The present disclosure relates to a prismatic secondary battery, and more particularly, to a prismatic secondary battery including one pair of stack type cells.

### BACKGROUND

Secondary batteries are rechargeable unlike primarily batteries, and due to the possibility of a compact size and a high capacity, a lot of research on secondary batteries is being carried out. Due to technology development and an increase in demand for mobile devices and also due to electric vehicles and energy storage systems that are emerging in line with the needs of the times for environmental protection, the demand for secondary batteries as energy sources is more rapidly increasing.

Secondary batteries are classified into coin type batteries, cylindrical type batteries, prismatic type batteries, and pouch type batteries according to a shape of a battery case. In such a secondary battery, an electrode assembly mounted in a battery case is a chargeable and dischargeable power generating device having a structure in which electrodes and a separator are stacked.

An electrode assembly may be approximately classified into a jelly-roll type electrode assembly in which a separator is interposed between a positive electrode and a negative electrode, each of which is provided in the form of a sheet coated with an active material, and then, the positive electrode, the separator, and the negative electrode are wound, a stack type electrode assembly in which a plurality of positive and negative electrodes with a separator interposed therebetween are sequentially stacked, and a stack/folding type electrode assembly in which stack type unit cells are wound together with a separation film having a long length.

A jelly-roll type electrode assembly is usually used in a prismatic secondary battery. However, as the size and capacity of a prismatic secondary battery have recently increased, various problems have arisen in applying a jelly-roll type electrode assembly. That is, in order to manufacture a jelly-roll electrode assembly, a device dedicated for winding is required, and in order to increase the size of an electrode assembly, a new winding device should be provided accordingly. Since the new winding device is a factor that increases manufacturing costs, an existing prismatic secondary battery uses a method of increasing the number of jelly-roll electrode assemblies and encapsulating the jelly-roll electrode assemblies in a battery case. However, there are disadvantages in that assemblability is lowered and a separate electric wire should be added. As a result, there is a problem in that a jelly-roll electrode assembly is not suitable for responding to various form factors.

In addition, when the size of a jelly-roll electrode assembly increases, winding quality is degraded, and a jelly-roll is expanded or dented during use of a secondary battery, which adversely affects the safety of the secondary battery.

In addition, a space for electrical connection of a jelly-roll electrode assembly and a small amount of free space due to a required injection amount of an electrolyte are formed in a battery case, and thus, a phenomenon (slip phenomenon) occurs in which the electrode assembly in the battery case shakes or slides due to an external impact. When a slip phenomenon occurs in the electrode assembly, there may be various problems in that a short circuit occurs due to electrical contact or an electrode tab is torn due to stress concentration on the electrode tab.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problem

The present disclosure is directed to solving various problems that arise in a conventional jelly-roll type electrode assembly as the size and capacity of a prismatic secondary battery increase.

The present disclosure is also directed to improving the safety of a prismatic secondary battery by suppressing an electrode assembly accommodated inside the prismatic secondary battery from slipping due to an external disturbance.

However, the technical objects to be solved are not limited to the above, and other objects that are not described herein should be clearly understood by those skilled in the art from the following descriptions of the present disclosure.

### Technical Solution

According to a first aspect of the invention, the present disclosure provides an electrode structure comprising: a first electrode assembly; a second electrode assembly; and a current collector plate comprising a positive electrode terminal and a negative electrode terminal, wherein each of the first electrode assembly and the second electrode assembly comprises a plurality of unit cells, and each of the plurality of unit cells includes a positive electrode, a negative electrode and a separator between the positive electrode and the negative electrode, wherein the positive electrode comprises a positive electrode tab and a positive electrode dummy tab and the negative electrode comprises a negative electrode tab and a negative electrode dummy tab, wherein the positive electrode tab and the negative electrode tab are disposed on a first side of the plurality of unit cells, wherein the positive electrode tabs of the first electrode assembly and the second electrode assembly are electrically connected to the positive electrode terminal, and the negative electrode tabs of the first electrode assembly and the second electrode assembly are electrically connected to the negative electrode terminal, and wherein the positive electrode dummy tabs and the negative electrode dummy tabs are disposed on a side of the plurality of unit cells other than the first side.

The number of the unit cells in the first electrode assembly may be the same as the number of the unit cells of the second electrode assembly.

The first and second electrode assemblies may be folded toward the current collector plate with the positive electrode terminal and the negative electrode terminal as a center.

Each of the first electrode assembly and the second electrode assembly may further comprise a half cell including a positive electrode or a negative electrode on a separator.

According to a second aspect of the invention, the present disclosure provides a prismatic battery comprising: the above electrode structure; a prismatic battery housing having an opening that accommodates the electrode structure; and an electrolyte, wherein the current collector plate seals the opening of the prismatic battery housing.

The positive electrode dummy tab and the negative electrode dummy tab may be electrically insulated from the positive electrode terminal and the negative electrode terminal of the current collector plate.

The positive electrode dummy tab and the negative electrode dummy tab may be fixed to the prismatic battery housing to support the first and second electrode assemblies.

Both the positive electrode dummy tab and the negative electrode dummy tab may be disposed on a side of the plurality of unit cells opposite to the first side.

The positive electrode dummy tab and the negative electrode dummy tab may be fixed to an inner surface of the prismatic battery housing.

Each of a pair of the positive electrode tab and the positive electrode dummy tab and a pair of the negative electrode tab and the negative electrode dummy tab may be aligned in a straight line in a height direction of the prismatic battery housing.

A pair of the positive electrode tab and the positive electrode dummy tab and a pair of the negative electrode tab and the negative electrode dummy tab may be not aligned in a straight line in a height direction of the prismatic battery housing.

Each of a pair of the positive electrode tab and the negative electrode dummy tab and a pair of the negative electrode tab and the positive electrode dummy tab may be aligned in a straight line in the height direction of the prismatic battery housing.

One of the positive electrode dummy tab or the negative electrode dummy tab may be electrically insulated from the prismatic battery housing.

The one of the positive electrode dummy tab or the negative electrode dummy tab electrically insulated from the prismatic battery housing may have a polarity opposite to that of the prismatic battery housing.

The one of the positive electrode dummy tab or the negative electrode dummy tab electrically insulated from the prismatic battery housing may be fixed to an insulator installed on an inner surface of the prismatic battery housing.

The insulator may include a tab insertion groove; and the one of the positive electrode dummy tab or the negative electrode dummy tab electrically insulated from the prismatic battery housing may be inserted into and fixed to the tab insertion groove.

A dummy tab that is not electrically insulated from the prismatic battery housing may be welded to an inner surface of the prismatic battery housing.

A polarity of the prismatic battery housing may be neutral; and the positive electrode dummy tab and the negative electrode dummy tab may be electrically insulated from the prismatic battery housing.

The positive electrode dummy tab and the negative electrode dummy tab may be fixed to an insulator installed on an inner surface of the prismatic battery housing.

The insulator may include a tab insertion groove; and each of the positive electrode dummy tab and the negative electrode dummy tab may be inserted into and fixed to the tab insertion groove.

According to a third aspect of the invention, the present disclosure provides a device comprising the above prismatic battery, wherein the device is an electric vehicle (EV).

### Advantageous Effects

By using a stack type electrode assembly, a prismatic battery having the above configuration of the present disclosure can respond flexibly to various form factors of a prismatic secondary battery that follows the trend of a large size and high capacity, and since a shape of the stack type electrode assembly is maintained well during use thereof, excellent quality can be secured even in terms of safety.

In addition, when a prismatic battery using a conventional jelly-roll type electrode assembly is charged and discharged, deformation such as thickness expansion occurs in some areas of a jelly roll. However, according to the present disclosure, it is possible to effectively solve a problem in that the dimensional stability of a module/pack is lowered due to the non-uniformity of the thickness expansion.

Furthermore, in a prismatic battery of the present disclosure, an electrode assembly may include a positive electrode dummy tab and a negative electrode dummy tab at a side opposite to a side at which a positive electrode tab and a negative electrode tab are formed, and the positive electrode dummy tab and the negative electrode dummy tab may be fixed to a battery case (prismatic battery housing). As a result, the electrode assembly can be fixed inside the battery case in two directions, and thus a support structure is improved. Accordingly, a slip phenomenon of the electrode assembly accommodated inside the prismatic secondary battery is suppressed during use, thereby preventing various problems such as a short circuit due to electrical contact or tearing of tabs to considerably improve the safety of a secondary battery.

However, the technical effects obtainable through the present disclosure are not limited to the above-described effects, and other effects that are not described herein will be clearly understood by those skilled in the art from the following descriptions of the present disclosure.

### BRIEF DESCRIPTION OF THE DRAWINGS

The accompanying drawings illustrate exemplary embodiments of the present disclosure and, together with the following detailed description, serve to provide further understanding of the technical spirit of the present disclosure. However, the present disclosure is not to be construed as being limited to the drawings.

FIG. 1 is a view illustrating an example of a conventional jelly-roll type electrode structure.

FIG. 2 is a view illustrating another example of a conventional jelly-roll type electrode structure.

FIG. 3 is a view illustrating a stack type electrode structure according to one embodiment of the present disclosure.

FIG. 4 is a view illustrating a stack type electrode structure according to another embodiment of the present disclosure.

FIG. 5 is a view illustrating an example of a prismatic battery including a stack type electrode structure according to the present disclosure.

FIG. 6 is a view illustrating a stack type electrode structure according to still another embodiment of the present disclosure.

FIGS. 7 to 9 are views illustrating various arrangement structures of a positive electrode dummy tab and a negative electrode dummy tab.

FIG. 10 is a view illustrating one example of a support structure of an electrode assembly in the prismatic battery of the present disclosure.

FIG. 11 is a view illustrating another example of a support structure of an electrode assembly in the prismatic battery of the present disclosure.

### DETAILED DESCRIPTION

While the present disclosure may be variously changed and have various embodiments, specific embodiments will be described in detail below.

However, it is to be understood that the present disclosure is not limited to the specific embodiments but includes all modifications, equivalents, and substitutions included in the spirit and the scope of the present disclosure.

In this application, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

Also, when a portion such as a layer, a film, an area, a plate, etc. is referred to as being “on” another portion, this includes not only the case where the portion is “directly on” another portion but also the case where still another portion is interposed therebetween. On the other hand, when a portion such as a layer, a film, an area, a plate, etc. is referred to as being “under” another portion, this includes not only the case where the portion is “directly under” another portion but also the case where still another portion is interposed therebetween. In addition, to be disposed “on” in the present application may include the case disposed at the bottom as well as the top.

The present disclosure relates to a stack type electrode structure. In one example, the stack type electrode structure includes first and second stack type electrode assemblies in which unit cells including a positive electrode and a negative electrode with a separator interposed therebetween are stacked vertically and a positive electrode tab and a negative electrode tab of each unit cell are disposed on the same side, and a current collector plate including a positive electrode terminal and a negative electrode terminal. Each of the first and second stack type electrode assemblies may further comprise at least one half cell including a positive electrode or a negative electrode on a separator.

Here, the positive electrode tab and the negative electrode tab of the first stack type electrode assembly are disposed to face the positive electrode tab and the negative electrode tab of the second stack type electrode assembly with the current collector plate interposed therebetween, and the positive electrode tab and the negative electrode tab of each of the first and second stack type electrode assemblies are bonded to the positive electrode terminal and the negative electrode terminal of the current collector plate.

As described above, by using a stack type electrode assembly, a prismatic secondary battery of the present disclosure can respond flexibly to various form factors of a prismatic secondary battery that follows the trend of a large size and high capacity, and since a shape of the stack type electrode assembly is maintained well during use thereof, it is possible to solve various disadvantages of a conventional jelly-roll type electrode assembly.

Hereinafter, a stack type electrode structure of the present disclosure and a prismatic secondary battery including the same will be described in detail with reference to the accompanying drawings. For reference, front and rear directions or up, down, left, and right directions for designating relative positions used in the following description are to help the understanding of the present disclosure and are based on directions shown in the drawings unless not specifically defined.

### First Embodiment

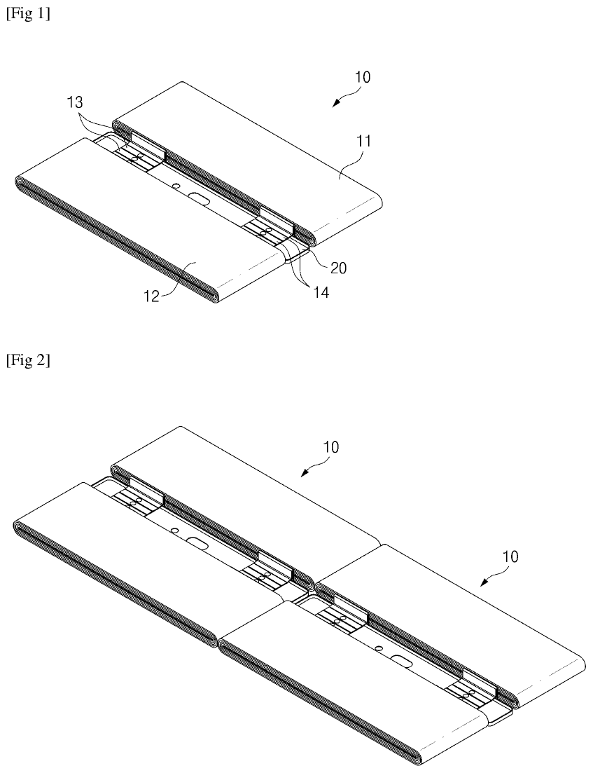

FIG. 1 is a view illustrating an example of a conventional jelly-roll type electrode structure 10.

In the conventional jelly-roll type electrode structure 10, one pair of jelly-roll type electrode assemblies 11 and 12, that is, a first jelly-roll type electrode assembly 11 and a second jelly-roll type electrode assembly 12, have a butterfly-shaped coupling structure (also referred to as a butterfly-shaped structure) with a current collector plate 20 interposed therebetween.

Here, an electrode structure is a structure formed by combining an electrode assembly and a current collector plate, and the definition of the electrode structure is equally applied in the following detailed description.

In addition, the first jelly-roll type electrode assembly 11 and the second jelly-roll type electrode assembly 12 are electrode assemblies 11 and 12 having a unidirectional structure in which a positive electrode tab 13 and a negative electrode tab 14 of each unit cell are disposed on the same side. In the jelly-roll type electrode assemblies 11 and 12, each of the positive electrode tabs 13 and the negative electrode tabs 14 face each other with the current collector plate 20 interposed therebetween.

The positive electrode tabs 13 and the negative electrode tabs 14 facing each other are coupled and electrically connected to a positive electrode terminal and a negative electrode terminal of the current collector plate 20, respectively, thereby completing the jelly-roll type electrode structure 10.

The conventional jelly-roll type electrode structure 10 has a disadvantage in that it is not easy to increase the size of the jelly-roll type electrode assemblies 11 and 12 to increase capacity and enlarge the jelly-roll type electrode assemblies 11 and 12. This is because a dedicated winding device is required to wind the jelly-roll type electrode assemblies 11 and 12 to a predetermined size and is also because, when the size of the jelly-roll type electrode assemblies 11 and 12 increases, winding quality is degraded, and a jelly-roll is expanded or dented during use of a secondary battery, which adversely affects the safety of the secondary battery.

Due to such a limitation and disadvantage of the jelly-roll type electrode structure 10, now, instead of increasing the size of the jelly-roll type electrode assemblies 11 and 12 themselves, as shown in FIG. 2, a plurality of jelly-roll type electrode structures 10 having the same size have been connected to overcome the limitation and disadvantage.

However, such a method is very limited in responding to secondary batteries having various sizes and has disadvantages in that assemblability is lowered, and also a separate electric wire should be added.

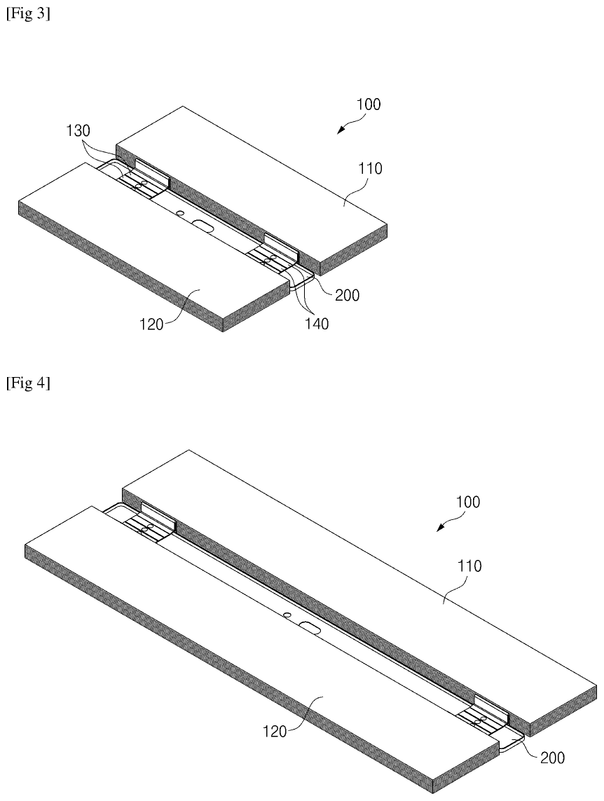

The present disclosure is directed to solving the disadvantages of the conventional jelly-roll type electrode structure 10, and a configuration according to the present disclosure is shown in FIG. 3.

The present disclosure relates to a stack type electrode structure 100. The stack type electrode structure 100 includes a first stack type electrode assembly 110 and a second stack type electrode assembly 120 in which unit cells including a positive electrode and a negative electrode with a separator interposed therebetween are stacked vertically and a positive electrode tab 130 and a negative electrode tab 140 of each unit cell are disposed on the same side, and a current collector plate 200.

The positive electrode tab 130 and the negative electrode tab 140 of the first stack type electrode assembly 110 are disposed to respectively face the positive electrode tab 130 and the negative electrode tab 140 of the second stack type electrode assembly 120 with the current collector plate 200 interposed therebetween. The positive electrode tab 130 and the negative electrode tab 140 of each of the first and second stack type electrode assemblies 110 and 120 are bonded to a positive electrode terminal 210 and a negative electrode terminal 220 of the current collector plate 200, respectively.

As described above, an electrode structure of the present disclosure is the stack type electrode structure 100. In other words, in the present disclosure, instead of a conventional jelly-roll type electrode assembly, the stack type electrode assemblies 110 and 120, in which the unit cells including the separator interposed between the positive electrode and the negative electrode are stacked vertically, are used.

Accordingly, in the present disclosure, since a dedicated winding device is not required in manufacturing the stack type electrode assemblies 110 and 120, it is possible to flexibly respond to various sizes and form factors by being free from a size limitation.

In addition, the stack type electrode assemblies 110 and 120 have an advantage in that, even when the stack type electrode assemblies 110 and 120 are enlarged, it is easy to maintain a uniform shape and quality. Since the shape of the stack type electrode assemblies 110 and 120 is maintained well even during use of a secondary battery, excellent quality can be secured even in terms of safety.

FIG. 4 is a view illustrating a stack type electrode structure 100 according to another embodiment of the present disclosure and illustrates a case in which sizes of first and second stack type electrode assemblies 110 and 120 are approximately doubled as compared with the stack type electrode structure 100 of FIG. 3.

As shown in FIG. 4, in the stack type electrode structure 100 of the present disclosure, even when capacities of the first and second stack type electrode assemblies 110 and 120 increase, the number of stack type electrode assemblies 110 and 120 is always two, and the capacities are adjusted using sizes of the first and second stack type electrode assemblies 110 and 120 themselves. In other words, even when the number of stacked unit cells and/or sizes of the unit cells of the first and second stack type electrode assemblies 110 and 120 are designed according to a plurality of specifications, the first and second stack type electrode assemblies 110 and 120 are always provided as one pair of stack type electrode assemblies 110 and 120.

This is because, as described above, a dedicated winding device is not required in manufacturing the stack type electrode assemblies 110 and 120, and thus there is almost no size limitation. Therefore, the stack type electrode structure 100 of the present disclosure can actively respond to prismatic secondary batteries having various sizes and capacities required by the market.

Meanwhile, in the stack type electrode structure 100 of the present disclosure as described above, the first and second stack type electrode assemblies 110 and 120 are folded in half toward the current collector plate 200 with the positive electrode terminal 210 and the negative electrode terminal 220 as a center, and in such a folded state, a prismatic secondary battery 1000 is formed.

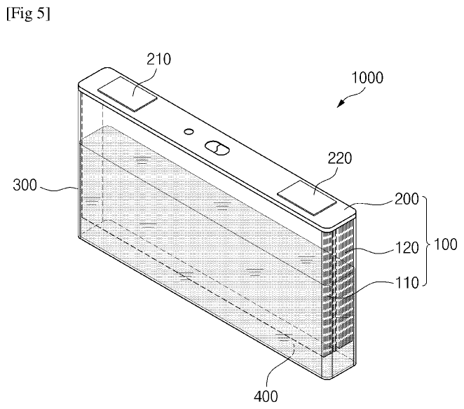

That is, as shown in FIG. 5, the prismatic secondary battery 1000 of the present disclosure includes the stack type electrode structure 100 folded in half, a battery case 300 having a hexahedral shape of which one surface is formed as an open surface to accommodate the stack type electrode structure 100, and an electrolyte 400 with which the battery case 300 is filled.

Here, the stack type electrode structure 100 is accommodated in the battery case 300, and the prismatic secondary battery 1000 is completed by sealing a space between the current collector plate 200 and the open surface of the battery case 300. For reference, the electrolyte 400, which is a component of the prismatic secondary battery 1000, is generally injected into the battery case 300 after the space between the current collector plate 200 and the open surface of the battery case 300 is sealed.

### Second Embodiment

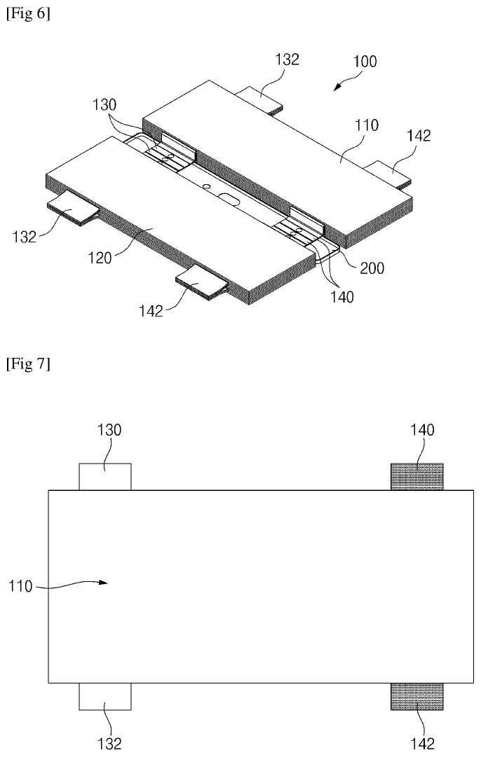

FIG. 6 is a view illustrating a stack type electrode structure 100 according to still another embodiment of the present disclosure.

A prismatic secondary battery 1000 of a second embodiment relates to a unidirectional secondary battery in which both a positive electrode terminal 210 and a negative electrode terminal 220 are disposed on one surface of a battery case 300, that is, on an upper surface in the illustrated example (FIG. 5). Correspondingly, a positive electrode tab 130 and a negative electrode tab 140 are also disposed on an upper portion of first and second stack type electrode assemblies 110 and 120.

Furthermore, in the second embodiment of the present disclosure, the stack type electrode structure 100 further includes a positive electrode dummy tab 132 and a negative electrode dummy tab 142 which are electrically separated from the positive electrode terminal 210 and the negative electrode terminal 220 of a current collector plate 200. The positive electrode dummy tab 132 and the negative electrode dummy tab 142 are formed at an uncoated portion on a side opposite to an uncoated portion at which the positive electrode tab 130 and the negative electrode tab 140 are formed. Accordingly, in the second embodiment, based on the drawing, the positive electrode tab 130 and the negative electrode tab 140 are disposed at an upper end of the first and second stack type electrode assemblies 110 and 120, and the positive electrode dummy tab 132 and the negative electrode dummy tab 142 are disposed at a lower end thereof.

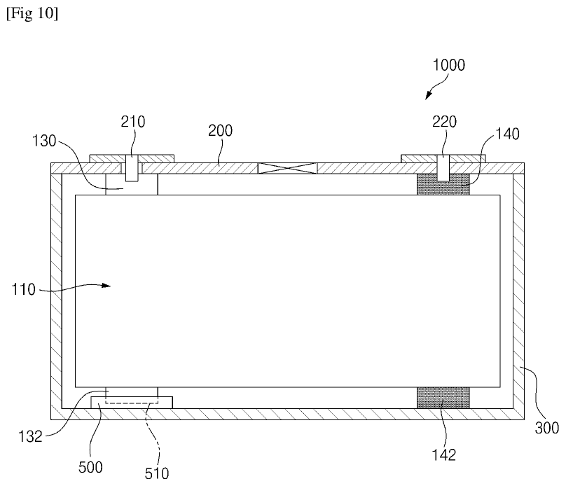

FIG. 10 is a view illustrating a support structure of the first and second stack type electrode assemblies 110 and 120 in the prismatic secondary battery 1000. Although only the first stack type electrode assembly 110 is shown in FIG. 10, the same support structure is also applied to the second stack type electrode assembly 120. As shown in the drawing, the positive electrode tab 130 and the negative electrode tab 140 may be fixed to the positive electrode terminal 210 and the negative electrode terminal 220 of the current collector plate 200 through welding, and the positive electrode dummy tab 132 and the negative electrode dummy tab 142 are fixed to a lower surface of the battery case 300.

As described above, in the prismatic secondary battery 1000 according to the second embodiment of the present disclosure, both upper and lower portions of the first and second stack type electrode assemblies 110 and 120 are fixed to the battery case 300. More specifically, the positive electrode tab 130, the negative electrode tab 140, the positive electrode dummy tab 132, and the negative electrode dummy tab 142 fix the first and second stack type electrode assemblies 110 and 120 to the battery case 300 through a four-point support structure. The four-point support structure is a structure that exerts strong support against external disturbances (shock, vibration, or the like). The first and second stack type electrode assemblies 110 and 120 supported at four points are prevented from slipping to prevent various problems such as a short circuit due to electrical contact or tearing of the electrode tabs 130 and 140, thereby considerably improving the safety of the prismatic secondary battery 1000.

In addition, since the positive electrode dummy tab 132 and the negative electrode dummy tab 142 are formed integrally with a positive electrode and a negative electrode of the first and second stack type electrode assemblies 110 and 120, when the battery case 300 has a polarity, at least one of the dummy tabs 132 or 142 needs to be electrically insulated from the battery case 300 in order to prevent an internal short circuit. For example, when the battery case 300 is electrically positive, the negative electrode dummy tab 142 should be electrically insulated from the battery case 300, and on the contrary, when the battery case 300 is negative, the positive electrode dummy tab 132 should be insulated from the battery case 300. When the battery case 300 needs to be electrically neutral, both the dummy tabs 132 and 142 need to be insulated from the battery case 300.

FIG. 10 illustrates an example of a case in which the battery case 300 is electrically negative, for example, is grounded. The positive electrode dummy tab 132 is fixed to an insulator 500 installed on an inner surface of the battery case 300, and the positive electrode dummy tab 132 fixed to the battery case 300 through the insulator 500 is electrically separated from the battery case 300. For example, the insulator 500 may include a tab insertion groove 510, and the positive electrode dummy tab 132 may be fixed by being inserted into the tab insertion groove 510 of the insulator 500 and pressed.

In addition, the negative electrode dummy tab 142 may also be fixed to the battery case 300 using the insulator 500, but since the negative electrode dummy tab 142 does not need to be insulated from the battery case 300 that is electrically negative, the negative electrode dummy tab 142 may be welded and fixed directly to the inner surface of the battery case 300.

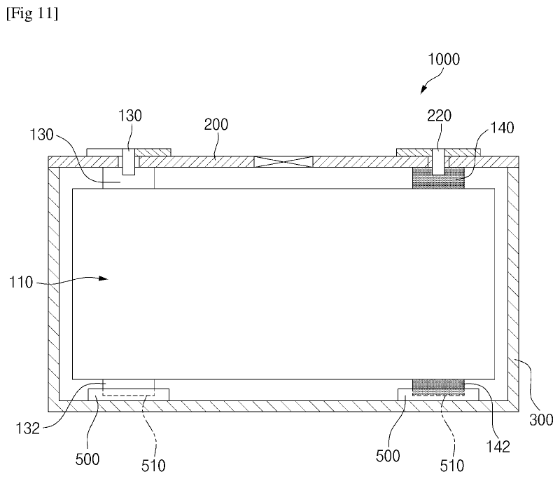

FIG. 11 illustrates a case in which the battery case 300 is electrically neutral. Both the positive electrode dummy tab 132 and the negative electrode dummy tab 142 are fixed to the insulator 500 installed on the inner surface of the battery case 300. Even in FIG. 11, the positive electrode dummy tab 132 and the negative electrode dummy tab 142 may be inserted into and fixed to the tab insertion groove 510 of the insulator 500.

Meanwhile, FIGS. 7 to 9 are views illustrating various arrangement structures of the positive electrode dummy tab 132 and the negative electrode dummy tab 142. It can be confirmed that there may be various arrangement relationships of the positive electrode dummy tab 132 and the negative electrode dummy tab 142 with respect to the positive electrode tab 130 and the negative electrode tab 140, and even in various arrangement structures, a four-point support structure of the stack type electrode assemblies 110 and 120 remains the same. For reference, although FIGS. 7 to 9 illustrate the first stack type electrode assembly 110, of course, the same arrangement may be applied to the second stack type electrode assembly 120.

First, referring to FIG. 7, each of a pair of the positive electrode tab 130 and the positive electrode dummy tab 132 and a pair of the negative electrode tab 140 and the negative electrode dummy tab 142 may be aligned to be positioned on a straight line that crosses one side and an opposite side thereof of the first stack type electrode assembly 110, i.e., a straight line in a height direction of the battery case 300. That is, the positive electrode dummy tab 132 directly faces the positive electrode tab 130, and the negative electrode dummy tab 142 also directly faces the negative electrode tab 140.

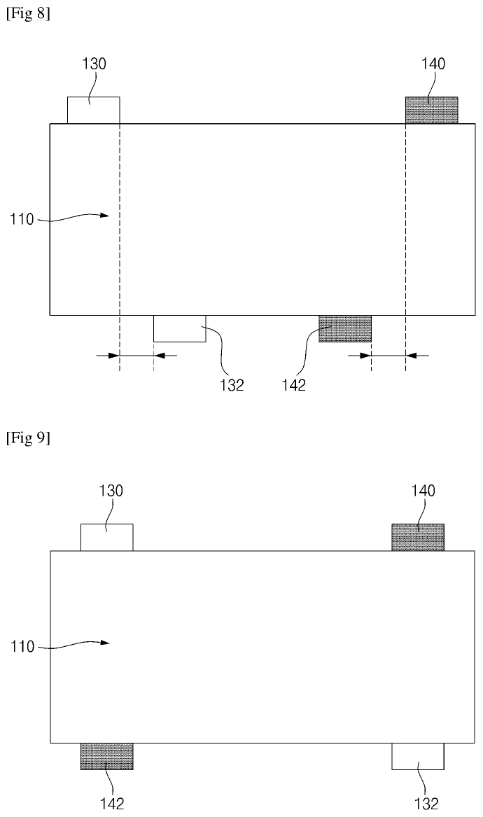

As compared with the first stack type electrode assembly 110 of FIG. 7, in the first stack type electrode assembly 110 of FIG. 8, each of a pair of the positive electrode tab 130 and the positive electrode dummy tab 132 and a pair of the negative electrode tab 140 and the negative electrode dummy tab 142 may be disposed and offset to be misaligned with respect to a straight line that vertically crosses the first stack type electrode assembly 110. That is, the first stack type electrode assembly 110 of FIG. 8 has a facing structure in which the positive electrode dummy tab 132 and the negative electrode dummy tab 142 are misaligned with the positive electrode tab 130 and the negative electrode tab 140, respectively. By breaking a vertical symmetry structure of a four-point support, a natural frequency is changed, and accordingly, it is possible to respond to various types of vibration.

FIG. 9 is a modification of FIG. 8, each of a pair of the positive electrode tab 130 and the negative electrode dummy tab 142 and a pair of the negative electrode tab 140 and the positive electrode dummy tab 132 may be aligned to be positioned on a straight line that crosses one side and an opposite side thereof of the first stack type electrode assembly 110. That is, the negative electrode dummy tab 142 has a structure facing the positive electrode tab 130, and the positive electrode dummy tab 132 has a structure facing the negative electrode tab 140. FIG. 9 shows that types (polarity) of the dummy tabs 132 and 142 respectively facing the electrode tabs 130 and 140 are not limited to the embodiment of FIG. 7.

The prismatic battery according to the present disclosure can be used in various devices, such as an electric vehicle (EV).

In the above, the present disclosure has been described in more detail through the drawings and embodiments. However, the configurations described in the drawings or the embodiments in the specification are merely embodiments of the present disclosure and do not represent all the technical ideas of the present disclosure. Thus, it is to be understood that there may be various equivalents and variations in place of them at the time of filing the present application.

What is claimed is:

1. An electrode structure, comprising:
a first electrode assembly;
a second electrode assembly; and
a current collector plate comprising a positive electrode terminal and a negative electrode terminal,
wherein each of the first electrode assembly and the second electrode assembly comprises a plurality of unit cells, and each of the plurality of unit cells includes a positive electrode, a negative electrode and a separator between the positive electrode and the negative electrode,
wherein the positive electrode comprises a positive electrode tab and a positive electrode dummy tab and the negative electrode comprises a negative electrode tab and a negative electrode dummy tab,
wherein the positive electrode tab and the negative electrode tab are disposed on a first side of the plurality of unit cells,
wherein the positive electrode tabs of the first electrode assembly and the second electrode assembly are electrically connected to the positive electrode terminal, and the negative electrode tabs of the first electrode assembly and the second electrode assembly are electrically connected to the negative electrode terminal, and
wherein the positive electrode dummy tabs and the negative electrode dummy tabs are disposed on a side of the plurality of unit cells other than the first side.

2. The electrode structure of claim 1, wherein a number of the unit cells in the first electrode assembly is the same as a number of the unit cells of the second electrode assembly.

3. The electrode structure of claim 1, wherein the first and second electrode assemblies are folded toward the current collector plate with the positive electrode terminal and the negative electrode terminal as a center.

4. The electrode structure of claim 1, wherein each of the first electrode assembly and the second electrode assembly further comprises a half cell including a positive electrode or a negative electrode on a separator.

5. A prismatic battery comprising:
the electrode structure of claim 3;
a prismatic battery housing having an opening that accommodates the electrode structure; and
an electrolyte,
wherein the current collector plate seals the opening of the prismatic battery housing.

6. The prismatic battery of claim 5, wherein the positive electrode dummy tab and the negative electrode dummy tab are electrically insulated from the positive electrode terminal and the negative electrode terminal of the current collector plate.

7. The prismatic battery of claim 5, wherein the positive electrode dummy tab and the negative electrode dummy tab are fixed to the prismatic battery housing to support the first and second electrode assemblies.

8. The prismatic battery of claim 5, wherein both the positive electrode dummy tab and the negative electrode dummy tab are disposed on a side of the plurality of unit cells opposite to the first side.

9. The prismatic battery of claim 5, wherein the positive electrode dummy tab and the negative electrode dummy tab are fixed to an inner surface of the prismatic battery housing.

10. The prismatic battery of claim 8, wherein each of a pair of the positive electrode tab and the positive electrode dummy tab and a pair of the negative electrode tab and the negative electrode dummy tab are aligned in a straight line in a height direction of the prismatic battery housing.

11. The prismatic battery of claim 8, wherein a pair of the positive electrode tab and the positive electrode dummy tab and a pair of the negative electrode tab and the negative electrode dummy tab are not aligned in a straight line in a height direction of the prismatic battery housing.

12. The prismatic battery of claim 11, wherein each of a pair of the positive electrode tab and the negative electrode dummy tab and a pair of the negative electrode tab and the positive electrode dummy tab are aligned in a straight line in the height direction of the prismatic battery housing.

13. The prismatic battery of claim 5, wherein one of the positive electrode dummy tab or the negative electrode dummy tab is electrically insulated from the prismatic battery housing.

14. The prismatic battery of claim 13, wherein the one of the positive electrode dummy tab or the negative electrode dummy tab electrically insulated from the prismatic battery housing has a polarity opposite to that of the prismatic battery housing.

15. The prismatic battery of claim 13, wherein the one of the positive electrode dummy tab or the negative electrode dummy tab electrically insulated from the prismatic battery housing is fixed to an insulator installed on an inner surface of the prismatic battery housing.

16. The prismatic battery of claim 15, wherein:
the insulator includes a tab insertion groove; and
the one of the positive electrode dummy tab or the negative electrode dummy tab electrically insulated from the prismatic battery housing is inserted into and fixed to the tab insertion groove.

17. The prismatic battery of claim 13, wherein a dummy tab that is not electrically insulated from the prismatic battery housing is welded to an inner surface of the prismatic battery housing.

18. The prismatic battery of claim 5, wherein:
a polarity of the prismatic battery housing is neutral; and
the positive electrode dummy tab and the negative electrode dummy tab are electrically insulated from the prismatic battery housing.

19. The prismatic battery of claim 18, wherein the positive electrode dummy tab and the negative electrode dummy tab are fixed to an insulator installed on an inner surface of the prismatic battery housing.

20. The prismatic battery of claim 19, wherein:
the insulator includes a tab insertion groove; and
each of the positive electrode dummy tab and the negative electrode dummy tab is inserted into and fixed to the tab insertion groove.

21. A device comprising the prismatic battery of claim 5, wherein the device is an electric vehicle (EV).
